(19) United States
(12) Patent Application Publication
(10) Pub. No.: US 2015/0302696 A1
(43) Pub. Date: Oct. 22, 2015

(54) Gaming Machine

(71) Applicant: Astra Games Ltd., Bridgend (GB)

(72) Inventor: Nigel Kelly, Cardiff (GB)

(21) Appl. No.: 14/600,700

(22) Filed: Jan. 20, 2015

(30) Foreign Application Priority Data
Jan. 13, 2014 (GB) 1400476.6

(51) Int. Cl. G07F 17/32

(52) U.S. Cl. CPC G07F 17/3246; G07F 17/3255

(57) ABSTRACT

A banknote recognition apparatus for a gaming machine, the apparatus comprising a note insertion mechanism for receiving a banknote having a face value, a scanner for scanning the banknote image, a data recognition system for determining at least the face value of said banknote from said image thereof and generating a data output, a processor for receiving said data output from said data recognition system and providing a positive or negative indicator, and an output means for offering or providing to a user a promotional reward only in response to a positive indicator from said processor.

### FIELD OF THE INVENTION

This invention relates to gaming machines or consoles of the type generally referred to as slot machines, and in particular the invention provides a new type of player recognition in such a machine.

### BACKGROUND

In licensed betting offices (LBOs), gaming or slot machines are often connected to a central server and players may be offered the opportunity to sign up for a so-called ‘members card’ for the betting office company. When a player inserts their members card into a machine, some games may be enhanced as a reward to the player for being a ‘member’. In addition, the central server, which recognises a player's credentials from the members card, can selectively offer that player a promotion, such as the so-called “Cash Match”, whereby the player receives double the credit for the money they have inserted.

However, many gaming or slot machines, especially those in locations other than licensed betting offices or similar establishments, are not connected to a central server and are, instead, stand-alone machines without external connectivity. In this case, clearly, there is no facility for offering players a members card or similar loyalty reward scheme, as there is no functionality within the machines for reading smart cards or storing and recognising player credentials. Nevertheless, it is highly desirable to provide within such machines the ability to selectively offer various promotions to a player.

### SUMMARY

Thus, in accordance with the present invention, there is provided a banknote recognition apparatus for a gaming machine, the apparatus comprising a note insertion mechanism for receiving a banknote having a face value, a scanner for scanning the banknote image, a data recognition system for determining at least the face value of said banknote from said image thereof and generating a data output, a processor for receiving said data output from said data recognition system and providing a positive or negative indicator, and an output means for offering or providing to a user a promotional reward only in response to a positive indicator from said processor.

The apparatus may comprise an image processor for locating a serial number within said banknote image and in this case, preferably comprises character recognition software for extracting said serial number from said banknote image. The processor may include an algorithm for comparing said extracted serial number with a set of serial numbers and determining if there is a match, and wherein said output means is configured to offer or provide a promotional reward to said user in the event of a match.

Also in accordance with the present invention, there is provided a method of selectively offering a promotional reward to a player of a gaming machine, comprising the steps of: receiving a banknote having a face value; scanning an image of said banknote; determining from said image at least said face value of said banknote; determining, using a decision-making algorithm and based on said image of said banknote, whether or not to offer or provide to said player a promotional reward; and, if so, offering or providing said promotional reward to said player.

The decision-making algorithm may be configured to determine whether or not to offer or provide to said player a promotional reward based on the face value of said banknote. The decision-making algorithm may be configured to determine whether or not to offer or provide to said player a promotional reward based on the time and date said banknote was received.

In an alternative embodiment, the method may further comprise the step of locating a serial number of said banknote from said image thereof. In this case, the method preferably further comprises the steps of using character recognition software to extract from said image of said banknote a digital signal representative of said serial number, and comparing said serial number with a set of serial numbers and determining if there is a match and, if there is a match, offering or providing said promotional reward to said player.

### BRIEF DESCRIPTION OF THE DRAWINGS

Embodiments of the present invention will now be described by way of examples only and with reference to the accompanying drawings, in which:

FIG. 1 is a schematic perspective view of an exemplary gaming or slot machine in which the apparatus and method of the present invention can be employed;

FIG. 2 is a schematic block diagram of a banknote recognition apparatus according to an exemplary embodiment of the present invention;

FIG. 3 is a flow diagram of a method according to a first exemplary embodiment of the present invention; and

FIG. 4 is a flow diagram of a method according to a second exemplary embodiment of the present invention.

### DETAILED DESCRIPTION

In the following detailed description, the methodology of the embodiments will be described and it is to be understood that it is within the capabilities of the non-inventive worker in the art to introduce the methodology on any standard microprocessor-based gaming console by means of appropriate adaptation and programming.

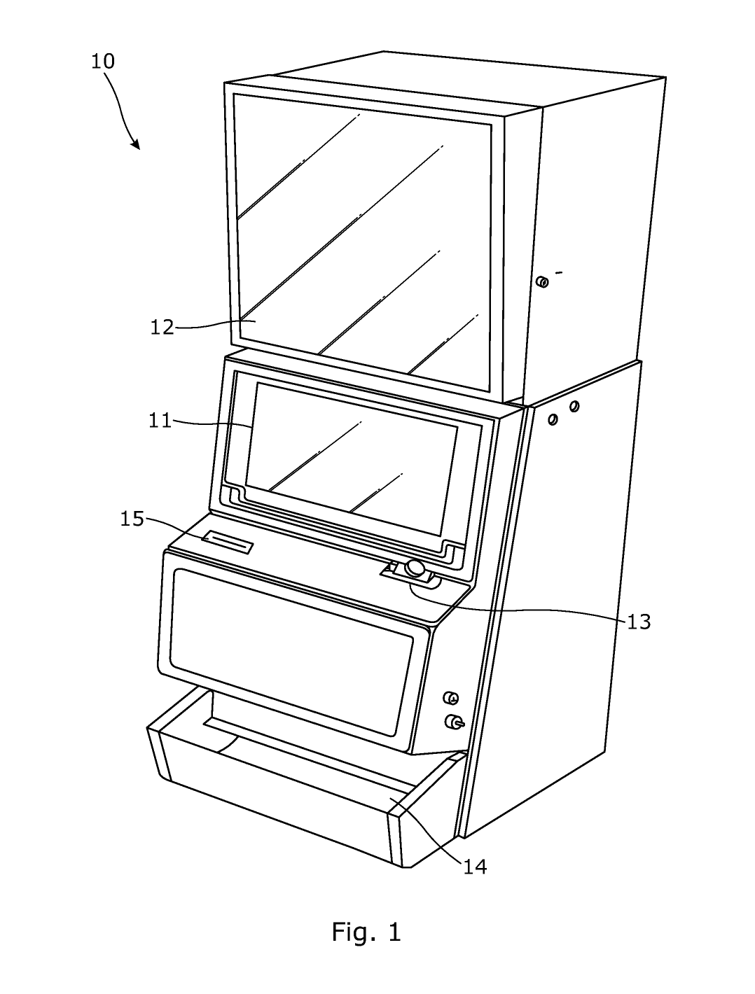

The present invention relates to a banknote recognition apparatus for a gaming or slot machine. Referring to FIG. 1 of the drawings, the illustrated embodiment of the invention is housed or mounted in a conventional gaming console cabinet 10 including a prize display 12, a game display 11, a coin entry slot 13, a banknote insertion slot 15, a payout tray 14 and internally mounted game control and banknote recognition processor circuits (not shown). It will be appreciated that the game control processor circuits and programming will be entirely dependent on the nature of the game(s) being offered on the machine, and the invention is in no way intended to be limited in this regard.

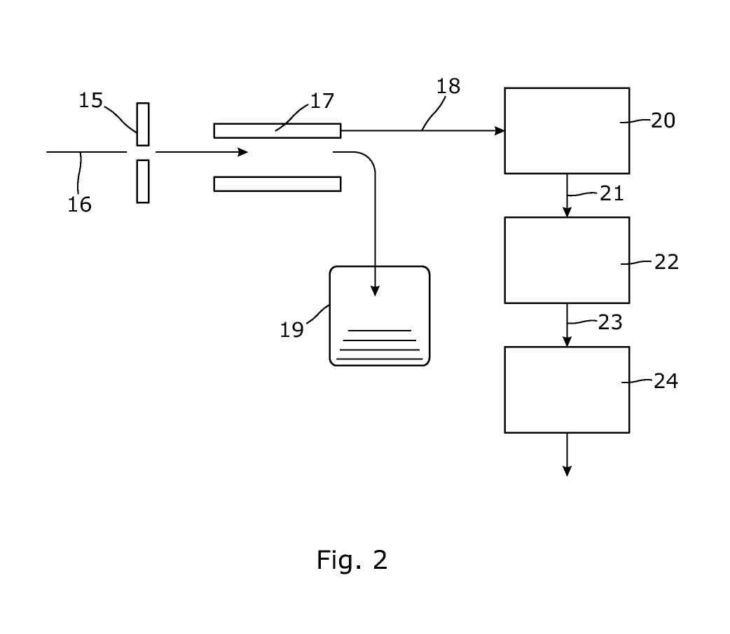

Referring to FIG. 2 of the drawings, a schematic diagram of the principal elements of a banknote recognition apparatus according to an exemplary embodiment of the present invention is provided, partially in block diagram form.

Thus, as shown, a banknote recognition apparatus according to an exemplary embodiment of the invention comprises a banknote insertion slot 15 for receiving a banknote 16. Propelling means (not shown) senses the insertion of a banknote and automatically propels said banknote through the insertion slot into an optical scanner 17, or similar image scanning means, which scans an image of the inserted banknote and generates an output signal 18 representative thereof. After the banknote, has been scanned, the propelling means further propels the banknote out of the scanner and into a banknote repository 19 for storage until collection thereof by the machine owner or other authorised operative.

The output signal 18 is fed to an image recognition module 20 for determining at least the face value of the inserted banknote. However, as, will be described later, the image recognition module may have additional functionality to vary or further enhance the criteria by which a user is offered a promotional reward. In any event, the image recognition module 20 generates an output signal 21, which is fed to a decision-making module 22 in which is run an algorithm for comparing the data 21 received from the image recognition module 20 against predetermined criteria, and generating an indicator data 23 which is representative of whether or not the player is to be offered a promotional reward. The indicator data 23 is then fed to another module 24, which may or may not be part of the game control processor circuit, which module, if it is determined that a promotional reward is to be offered to the player, causes the selected promotional reward to be offered or implemented.

It will be appreciated that the indicator data 23 need not be a positive data signal. For example, the apparatus could be arranged such that, if a promotional reward is to be offered, a positive signal is generated and transmitted to the module 24, but if no promotional reward is to be offered, the respective data line could simply remain low, rather than a physical signal being generated, or vice versa (i.e. the default situation is that a promotional reward is to be offered, unless the data line 23 goes high).

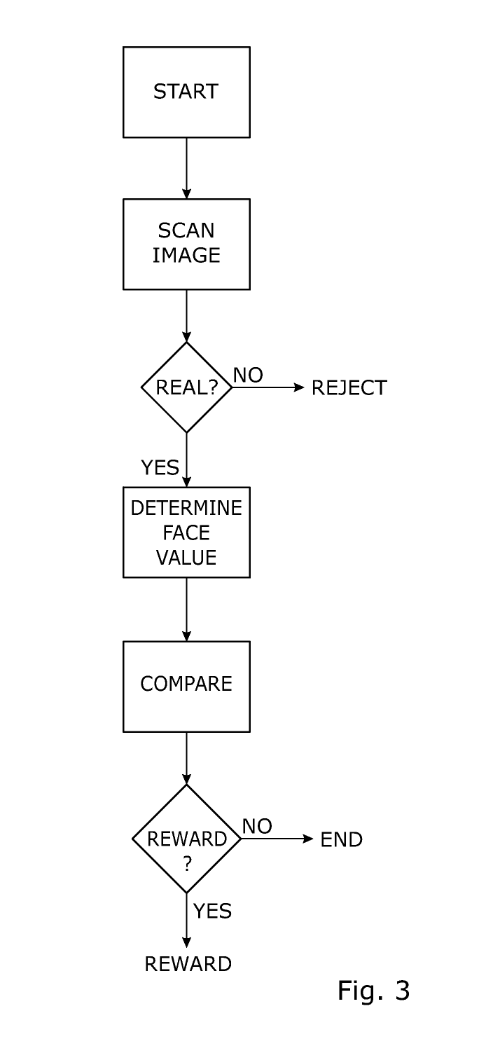

FIG. 3 is a flow chart representative of a method, or part of a method, according to a first exemplary embodiment of the present invention. At START, the method is triggered by the insertion of a banknote into the machine. There are many different mechanisms known in the art for sensing the insertion of a banknote. For example, in its simplest form, optical sensing can be used, whereby when an optical beam is interrupted by the insertion of a bank note, a signal is generated and the process is triggered.

The banknote is fed to the scanner which scans or captures image data from the note, and this data is (optionally) used first to determine firstly if it is indeed a banknote at all and secondly, if it is counterfeit. Automatic counterfeit banknote detection mechanisms are known in the art, and will not be discussed further herein.

If the inserted note is determined not to be a genuine banknote, it is rejected (or retained and an alarm sounded, as required). If the banknote is accepted as genuine, image recognition software is employed to determine from the image data at least the face value of the bank note. In this case, the criteria for whether or not a promotional reward is to be offered is based on the face value of the note, so the determined face value is then compared against the predetermined criteria for offering a promotional reward (for example, all notes above a certain denomination will receive a promotional reward, and notes below that denomination will not), and an output generated if a promotional reward is to be offered. If no promotional reward is to be offered, an indicative signal may also be generated, or the output line may simply stay low as a result of the comparison step.

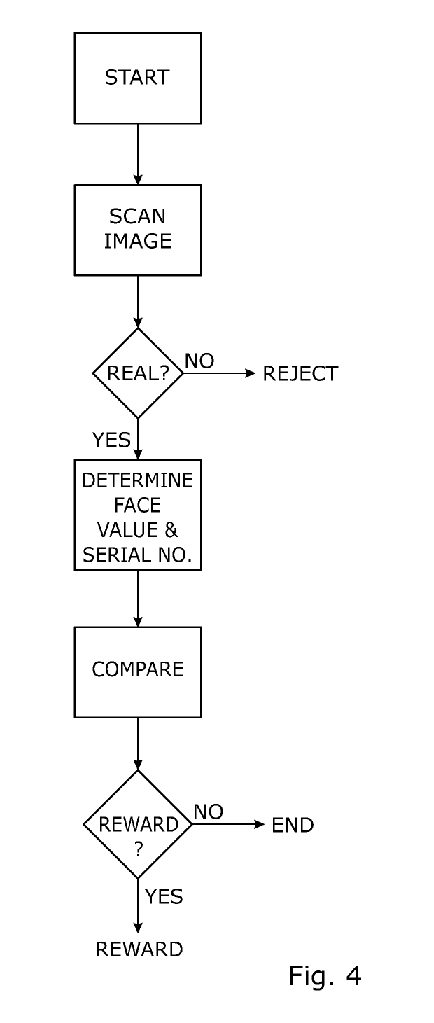

Referring now to FIG. 4 of the drawings, a method according to a second exemplary embodiment of the present invention is similar in many respects to that described with reference to FIG. 3 of the drawings. Thus, at START, the method is triggered by the insertion of a banknote into the machine. There are many different mechanisms known in the art for sensing the insertion of a banknote. For example, in its simplest form, optical sensing can be used, whereby when an optical beam is interrupted by the insertion of a bank note, a signal is generated and the process is triggered.

The banknote is fed to the scanner which scans or captures image data from the note, and this data is (optionally) used first to determine firstly if it is indeed a banknote at all and secondly, if it is counterfeit. If the inserted note is determined not to be a genuine banknote, it is rejected (or retained and an alarm sounded, as required). If the banknote is accepted as genuine, image recognition software is employed to determine from the image data the face value of the bank note. The image recognition software in this case is also configured to cross reference the note value to the serial number position on the note, such that the serial number can be extracted from the scanned image. The serial number image is then processed using character recognition software to determine the serial number.

Data representative of the serial number is transmitted through a win/lose lottery-type algorithm which compares the serial number against winning serial numbers and determines whether the inserted banknote ‘wins’ or ‘loses’ accordingly. In the event of a ‘win’, a promotional reward is offered or provided to the player, as in the previous embodiment. Once again, a ‘lose’ result from the algorithm may result in an express ‘lose’ signal or may, alternatively, result in the output remaining low.

It will be appreciated by persons skilled in the art that numerous variations and/or modifications may be made to the invention as shown in the specific embodiments without departing from the scope of the invention as claimed. The present embodiments are, therefore, to be considered in all respects as illustrative and not restrictive.

1. A method of selectively offering a promotional reward to a player of a gaming machine, comprising the steps of: receiving a banknote having a face value; scanning an image of said banknote; determining from said image at least said face value of said banknote; determining, using a decision-making algorithm and based on said image of said banknote, whether or not to offer or provide to said player a promotional reward; and, if so, offering or providing said promotional reward to said player.

2. A method according to claim 1, wherein said decision-making algorithm is configured to determine whether or not to offer or provide to said player a promotional reward based on the face value of said banknote.

3. A method according to claim 1, wherein said decision-making algorithm is configured to determine whether or not to offer or provide to said player a promotional reward based on the time and date that said banknote was received.

4. A method according to claim 1, further comprising the step of locating a serial number of said banknote from said image thereof.

5. A method according to claim 1, comprising the step of using character recognition software to extract from said image of said banknote a digital signal representative of said serial number.

6. A method according to claim 5, further comprising the step of comparing said serial number with a set of serial numbers and determining if there is a match and, if there is a match, offering or providing said promotional reward to said player.

7. A banknote recognition apparatus for a gaming machine, the apparatus comprising a note insertion mechanism for receiving a banknote having a face value, a scanner for scanning the banknote image, a data recognition system for determining at least the face value of said banknote from said image thereof and generating a data output, a processor for receiving said data output from said data recognition system and providing a positive or negative indicator, and an output means for offering or providing to a user a promotional reward only in response to a positive indicator from said processor.

8. Apparatus according to claim 7, configured to determine whether or not to offer or provide to said player a promotional reward based on the face value of said banknote.

9. Apparatus according to claim 7, configured to determine whether or not to offer or provide to said player a promotional reward based on the time and date that said banknote was received.

10. Apparatus according to claim 7, comprising an image processor for locating a serial number within said banknote image.

11. Apparatus according to claim 8, comprising character recognition software for extracting said serial number from said banknote image.

12. Apparatus according to claim 10, configured to compare said extracted serial number with a set of serial numbers and determine if there is a match, and wherein said apparatus is further configured to offer or provide a promotional reward to said user in the event of a match.
